(19) United States
(12) Patent Application Publication
(10) Pub. No.: US 2026/0134023 A1
(43) Pub. Date: May 14, 2026

(54) SYSTEMS AND METHODS FOR GENERATING FACT OBJECTS FROM A CORPUS OF DOCUMENTS

(71) Applicant: RELATIVITY ODA LLC, Chicago, IL (US)

(72) Inventors: Nathan Reff, Rochester, NY (US); Aron Ahmadia, Arlington, VA (US)

(21) Appl. No.: 19/386,822

(22) Filed: Nov. 12, 2025

Related U.S. Application Data
(60) Provisional application No. 63/719,260, filed on Nov. 12, 2024.

(51) Int. Cl. G06F 16/34; G06F 16/332; G06F 16/334; G06F 40/295; G06N 5/022; G06N 20/00

(52) U.S. Cl. CPC G06F 16/345; G06F 16/3326; G06F 16/334; G06F 40/295; G06N 5/022; G06N 20/00

(57) ABSTRACT

A computer system may obtain a fact extraction prompt. The fact extraction prompt is configured to control how a fact generating machine learning model extracts or summarizes content of reference documents included in a corpus of documents. The computer system may input, into the fact generating machine learning model, the fact extraction prompt and one or more reference documents from the corpus of documents to identify one or more facts included in the one or more reference documents, populate respective data fields of one or more fact objects based upon the one or more facts identified by the fact generating machine learning model and generate one or more fact summaries for the matter based on the one or more fact objects. The one or more fact summaries include structured presentations of at least some of the one or more fact objects according to contents of the data fields.

### CROSS-REFERENCE TO RELATED APPLICATIONS

This application claims priority to U.S. patent application Ser. No. 63/719,260, entitled “Systems and Methods for Generating Fact Objects from a Corpus of Documents” (filed Nov. 12, 2024), the entire contents of which are hereby incorporated by reference.

### FIELD

The present disclosure generally relates to computer systems for processing, managing, and analyzing a corpus of electronic documents and, more particularly, to systems and methods for generating fact objects from a corpus of documents.

### BACKGROUND

Document management and analysis tools are important systems for identifying useful material from large otherwise unwieldy sets of electronic documents. In particular, the extreme increase in document generation produced by the advent of the widespread adoption of electronic devices (computers, smart phones, tablets, etc.) and electronic software tools (email, digital chat, word processing, etc.) has made prior methods of manual document review and analysis impractical. However, the current tools for managing and analyzing a large corpus of documents rely on combinations of generic search algorithms and user inputs to generate surface-level classifications of documents. As a result, the conventional tools are unable to provide the deeper insights that help users understand the content included across the corpus of electronic documents.

Accordingly, there is a need for systems and methods that can automatically analyses and process a set of electronic documents to identify facts included therein and generate digital workspace fact objects from such identified facts in an automatic manner, which can then be utilized to extract deeper insights about a corpus of electronic documents than possible using currently existing tools.

### SUMMARY

In some aspects, the techniques described herein relate to a computer system including: one or more processors; and one or more non-transitory, computer-readable media storing instructions that, when executed by the one or more processors, cause the computer system to: obtain a fact extraction prompt associated with a matter, wherein the fact extraction prompt is configured to control how a fact generating machine learning model extracts or summarizes content of reference documents included in a corpus of documents associated with a workspace; input, into a fact generating machine learning model, the fact extraction prompt and one or more reference documents from the corpus of documents to identify one or more facts included in the one or more reference documents; populate respective data fields of one or more fact objects based upon the one or more facts identified by the fact generating machine learning model; and generate one or more fact summaries for the matter based on the fact objects, the one or more fact summaries including structured presentations of at least some of the one or more fact objects according to contents of the data fields.

In some aspects, the techniques described herein relate to a computer-implemented method for generating a one or more fact objects for one or more reference documents for a matter, the method including: obtaining a fact extraction prompt associated with a matter, wherein the fact extraction prompt is configured to control how a fact generating machine learning model extracts or summarizes content of reference documents included in a corpus of documents associated with a workspace; inputting, into a fact generating machine learning model, the fact extraction prompt and one or more reference documents from the corpus of documents to identify one or more facts included in the one or more reference documents; populating respective data fields of one or more fact objects based upon the one or more facts identified by the fact generating machine learning model; and generating one or more fact summaries for the matter based on the fact objects, the one or more fact summaries including structured presentations of at least some of the one or more fact objects according to contents of the data fields.

### BRIEF DESCRIPTION OF THE DRAWINGS

FIG. 1 is a block diagram of a computing environment in accordance with one or more embodiments.

FIG. 2 is a partial details block diagram of generating one or more facts using the computing environment of FIG. 1 in accordance with one or more embodiments.

FIG. 3 is a schematic diagram showing a correspondence between a fact output from a fact generating machine learning model of the computing environment of FIG. 1 and a fact object of a workplace in accordance with one or more embodiments.

FIGS. 4A-4D illustrate one or more fact summaries generated using the computing environment of FIG. 1 in accordance with one or more embodiments.

FIG. 5 is a flow diagram of a method in accordance with one or more embodiments.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

The systems and methods described herein relate to new systems and methods for processing, managing, and analyzing workspace objects that relate to a corpus of electronic documents. In particular, the systems and methods described herein describe systems and methods for generating fact objects by populating data fields of newly generated or already existing fact objects with fact materials extracted or summarized from the corpus of documents. As described herein, the fact summarization and extraction is accomplished through use of an artificial intelligence (AI) of machine learning (ML) model.

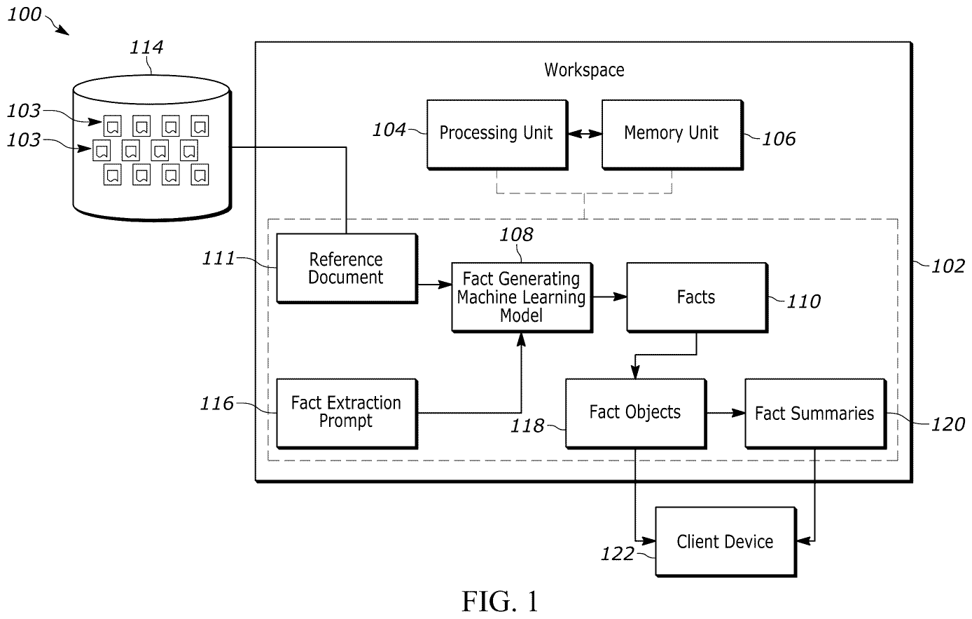

With reference now to FIG. 1 a computing environment 100 for generating fact objects is shown. The computing environment 100 includes a workspace 102. The workspace 102 may be associated with a corpus of documents 103, such as a set of documents associated with an eDiscovery project. Such documents in the corpus of documents 103 may have file types. Examples of the file type include: an email file, a word processing file, a spreadsheet file, an audio recording, imagery data (e.g., image and/or video data), a text message, etc. The workspace 102 and/or the components thereof may be implemented as software or hardware modules within a cloud and/or distributed computing system (e.g., Amazon Web Services (AWS) or Microsoft Azure). Accordingly, the components of the workspace 102 may include separate logical addresses via which the components are accessible via a bus or other messaging channel supported by the cloud computing system. In some embodiments, the workspace 102 includes multiple instances of the same component to increase the ability the parallelization for the various functions performed via the respective components.

A processing unit 104 and a memory unit 106 may implement the computing environment 100 and the workspace 102. More particularly, the processing unit 104 and the memory unit 106 may comprise portions of cloud and/or distributed computing system that implements the workspace 102. Processing unit 104 includes one or more processors, each of which may be a programmable microprocessor that executes software instructions stored in memory unit 106 to execute some or all of the functions of workspace 102 as described herein. Processing unit 104 may include one or more graphics processing units (GPUs) and/or one or more central processing units (CPUs), for example. Alternatively, or in addition, one or more processors in processing unit 104 may be other types of processors (e.g., application-specific integrated circuits (ASICs), field-programmable gate arrays (FPGAs), etc.), and some of the functionality of workspace 102 as described herein may instead be implemented in hardware. Memory unit 106 may include one or more volatile and/or non-volatile memories or similar computer readable media. Any suitable memory type or types may be included in memory unit 106, such as read-only memory (ROM) and/or random-access memory (RAM), flash memory, a solid-state drive (SSD), a hard disk drive (HDD), and so on. Collectively, memory unit 106 may store one or more software applications, the data received/used by those applications, and the data output/generated by those applications.

In particular, memory unit 106 stores the software that, when executed by processing unit 104, perform various functions of the computing environment 100 related to execution of fact generating machine learning model 108 to identify, extract, and/or generate one or more facts 110 from a reference document 111. The one or more facts 110 may be output in as raw unstructured text or data or in a structured text or other data format with headings and delineators for different components, parts, sections, etc. Example structured output formats can include JavaScript Object Notation (JSON) file types, Extensible Markup Language (XML) file types, etc. As described in more detail herein, each of the one or more facts 110 output from the fact generating machine learning model 108 may include different components, parts, sections, etc. that include directly extracted text (e.g., a snippet) from the reference document 111, summary text of the reference document 111 either generally or in relation to predefined issues or concepts, and/or one or more metrics or indicators that provide a high level context of the one or more facts 110 in relation to the predefined issues or concepts.

As shown in FIG. 1, the corpus of documents 103 is accessible via the workspace 102. The corpus of documents 103 may include a set of electronic documents (digitized paper documents, electronically generated documents, documents exported from user devices, etc.) that have been ingested into the workspace 102. In some embodiments, the corpus of documents relates to a single matter being processed, managed, or analyzed by the computing environment 100 (e.g., a litigation, a discovery request, a research project, etc.). Initially, the processing unit 104 ingests each document in the corpus of documents 103 so that they are accessible by the workspace 102. This ingestion pipeline includes the processing unit 104 assigning each document a unique identifier and performing other pre-processing tasks such as performing optical character recognition (OCR), metadata extraction or processing, etc.

In the illustrated embodiment, the corpus of documents 103 is maintained at a data store 114 after ingestion by the processing unit 104. The data store 114 may be implemented as a database, data lake, memory, or other digital storage medium known in the art. Accordingly, the data store 114 may be file system data store, an object-based data store, or other type of data store utilized in the art. Depending on the embodiment, the data store 114 may be implemented locally at the workspace 102, externally at an external data storage service, or a combination thereof. The workspace 102, via the processing unit 104, may be in wired or wireless communication with the external data storage service.

As illustrated, the processing unit 104 may select a reference document 111 from the corpus of documents 103 to identify one or more facts associated therewith. For example, the processing unit 104 may select documents from the corpus of documents 103 that are identified as responsive to a production request and/or are among an identified set of key documents as the reference document 111. In particular, the processing unit 104 may identify responsive documents and/or key documents by processing the corpus of documents 103 through various machine learning models. Furthermore, in some embodiments, the processing unit 104 may use other methods to filter or select the reference document 111 from the corpus of documents 103. These other methods may include, but are not limited to, keyword search techniques, advanced search techniques beyond keywords, other machine learning models, etc.). In some embodiments, the processing unit 104 sequentially selects every document in the corpus of documents 103 as a reference document 111 for processing through the fact generating machine learning model 108. However, in other embodiments, the processing unit 104 only selects a subset of the corpus of documents 103 as a reference document 111 for processing with the fact generating machine learning model 108. Additional details on selecting a subset of documents in the corpus of documents 103 may be found in U.S. Provisional Application 63/702,637 filed Oct. 2, 2024, the entire disclosure of which is hereby incorporated by reference.

Alternatively, in some embodiments, the processing unit 104 may select a document as the reference document 111 as part of the ingestion pipeline for that document. For example, the processing unit 104 may process each document in the corpus of documents 103 through the fact generating machine learning model 108 after assigning the document the unique identifier and performing the additional pre-processing tasks. Processing the documents through the fact generating machine learning model 108 as part of the ingestion pipeline may increases processing efficiency and save reading and writing actions with respect to the data store 114.

The fact generating machine learning model 108 may analyze the reference document 111 to identify one or more facts 110 associated therewith. The fact generating machine learning model 108 comprises a set of interconnected nodes, layers, trained parameter values (e.g., multiplicative weights, additive bias, etc.), etc. The trained parameters are set via backpropagation or other similar techniques in a training process that uses historical data inputs. Various architectures for the fact generating machine learning model 108 are possible, including, but not limited to, convolutional neural network (CNN) architectures, transformer architectures, recurrent/recursive neural network (RNN) architectures, sorting/clustering architectures, etc. The trained parameter values of the fact generating machine learning model 108 are set via the iterative training process in ways that identify or recognize patterns and trends in the historical data inputs. In some embodiments, the fact generating machine learning model 108 includes a large language model (LLM). The LLM can be a model trained by a third party and accessed by the workspace 102 via an application programming interface (API). The LLM can also be a fine-tuned public model (e.g., a model that is initially trained on publicly available or third-party data and tuned using private/proprietary data accessible by the workspace 102) or a full privately trained model managed by the workspace 102 (e.g., a model that is fully trained by the workspace 102 on private/proprietary data and/public data accessible thereto).

A fact extraction prompt 116 may be input to the fact generating machine learning model 108, along with the reference document 111, to direct how the fact generating machine learning model 108 analyzes and processes the reference document 111. In particular, the fact extraction prompt 116 is configured to control how the fact generating machine learning model 108 analyzes content of the reference document 111 to identify and output the one or more facts 110. The fact extraction prompt 116 may be tailored to the matter associated with the workspace. For example, the instructions may define how to identify facts as they relate to the predetermined issues or concepts. As used herein, the terms “fact” or “facts” are hereby defined to refer to text or metadata of a document that describe at least particular events that transpired, people and/or entities involved in said events, actions taken by the people or entities, contextual details of the events such as dates, etc. The instructions may also define how to generate component parts of the output one or more facts 110. In general, the components of each of the one or more facts 110 may include generated summaries, indicators, metrics, etc. based on content of the reference document 111 (including any metadata associated therewith) and/or extracted snippets from the reference document 111. The fact extraction prompt 116 may define each component part that is to be output as part of each of the one or more facts 110 and include dedicated instructions for how the fact generating machine learning model 108 produces that component with reference to the contents of the reference document 111 and the predetermined issues or concepts noted in the fact extraction prompt 116. The fact extraction prompt 116 may also instruct the fact generating machine learning model 108 to package the components of each of the one or more facts 110 in a particular output format and structure.

As shown in FIG. 1, the one or more facts 110 output from the fact generating machine learning model 108 may be processed by the processing unit 104 to generate or update one or more fact objects 118 associated with the workspace 102. The one or more fact objects 118 may be data objects that include a plurality of data fields for different aspects of a fact. At least some of the plurality of data fields of the one or more fact objects 118 are populated based upon the one or more facts 110 identified by the fact generating machine learning model 108. Other data fields may be populated based on user inputs. In embodiments where the fact extract prompt 116 instructs the fact generating machine learning model 108 to output the one or more facts 110 in an unstructured text or other unstructured format, the processing unit 104 may parse the output one or more facts 110 to identify sections related to each data field of the one or more fact objects 118. Alternatively, in embodiments where the fact extract prompt 116 instructs the fact generating machine learning model 108 to output the one or more facts 110 in a structured format, the processing unit 104 may directly map the sections of the structured format to the data fields of the one or more fact objects 118. However, it should be appreciated that in some embodiments, the processing unit 104 may also parse the structured format type outputs to identify the relevant sections for each data field of the one or more fact objects 118.

In some embodiments, the processing unit 104 may process multiple reference documents in serial or parallel batches. For example, the workspace 102 may instantiate multiple instances of the fact generating machine learning model 108 to process multiple reference documents 111 in parallel. Furthermore, in some embodiments, the processing unit 104 may analyze documents using the fact generating machine learning model 108 as the document is ingested into the workspace 102.

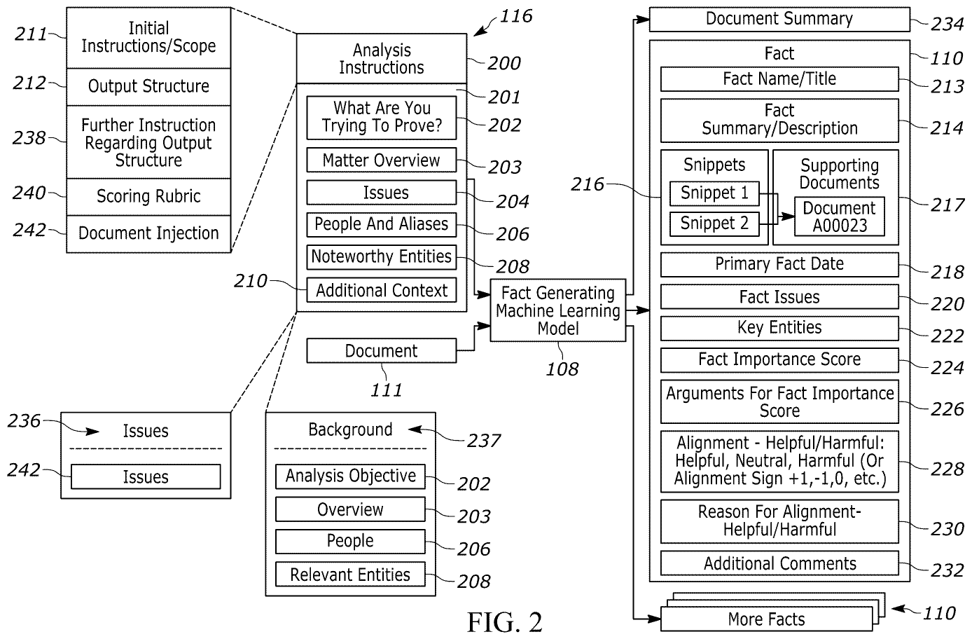

In some embodiments, the fact generating machine learning model 108 may produce duplicate facts 110 when processing a reference document 111. For example, in some embodiments, the one or more facts 110 output from the fact generating machine learning model 108 may relate to a same fact documented in different sections of the reference document 111 or refer to the same concept using different terminology. In these embodiments, the processing unit 104 may be configured to analyze all of the one or more facts 110 output by the fact generating machine learning model 108 from a single reference document 111 to determine whether any contents of the one or more facts 110 are exact or semantic matches to each other. The processing unit 104 may utilize information searching and matching algorithms known in the art to identify whether the contents in the one or more facts 110 match each other. For example, the processing unit 104 may determine a similarity score or ranking metric indicative of similarity between the contents of each of the one or more facts 110. In these embodiments, the processing unit 104 may determine a match between the content of different facts 110 when the similarity score or ranking metric satisfies a preconfigured threshold. In some embodiments, the searching and matching algorithms may be constrained to certain components of the one or more facts 110 such as a name component, summary component, etc. (see e.g., the fact name 213 and the fact description 214 described in connection with FIG. 2).

In some embodiments, when the processing unit 104 identifies a match between two or more facts 110, the processing unit 104 may merge together those facts and/or discard duplicate facts. For example, in cases where there is an exact match between the contents of the facts 110, the processing unit 104 may be configured to discard the duplicate material. However, discarding duplicates may be limited to situations where there is an exact match between all of the contents of multiple facts 110. In cases where there is a semantic match or no match at all between different contents of otherwise matched facts 110, the processing unit 104 may be configured to perform a non-destructive merge of the matching one or more facts 110. For example, the processing unit 104 may be configured to append together the contents of the facts 110 that are not exact matches or generate a new content that combines the content of the matched facts 110. In some embodiments, generating the new content may include averaging values together or inputting the contents of the facts 110 back into the fact generating machine learning model 108 or another similar model to produce a combined summary.

Furthermore, in some embodiments, the processing unit 104 may generate duplicate facts when different reference documents 111 are input into the fact generating machine learning model 108. These duplicate facts may occur from inadvertent processing of the same document multiple times or because a similar fact is included in multiple different documents in the corpus of documents 103. To promote efficiency and avoid creating substantively duplicate fact objects 118, the processing unit 104 may identify whether a similar fact object 118 exists prior to generating a new fact object 118.

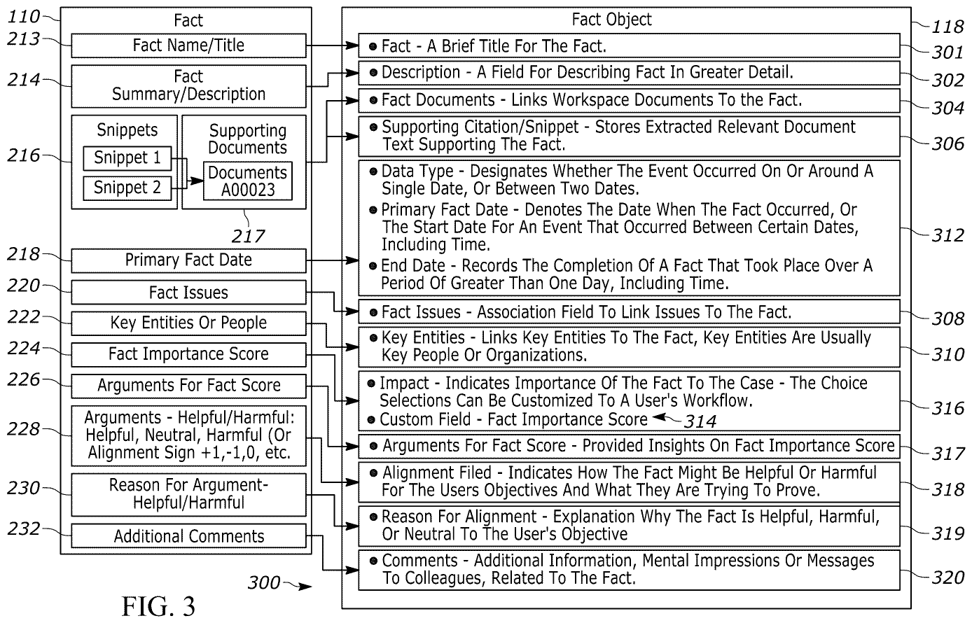

After the processing unit 104 finishes deduplication of the facts 110, the processing unit 104 may then update one or more fact objects 118 to include the content of the generated facts 110. To identify whether a similar fact object 118 for a fact 110 exists, the processing unit 104 may be configured to analyze the existing fact objects 118 to determine whether any of the one or more fact objects 118 is sufficiently similar such that the fact object 118 should be updated to include information from the fact 110. For example, a matching fact object 118 may have data fields populated with exact or semantic matches to the fact 110. As another example, the processing unit 104 may utilize similar information searching and matching algorithms as described above to identify whether the information in a fact 110 matches contents of an existing fact object 118. The thresholds associated with searching and matching algorithms may be the same or different from the threshold described above for determining matches between facts 110 output from a single execution of the fact generating machine learning model 108. In some embodiments, the searching and matching algorithms may be constrained to certain fields of the one or more fact objects 118 such as a name field, summary field, etc. (see e.g., the fact name 213, fact title field 301, and the description field 302 described in connection with FIG. 3).

When the processing unit 104 fails to identify a match between the content of the fact 110 and an existing fact object 118, the processing unit 104 may generate a new fact object 118 and populate the data fields thereof with the content of the fact 110. On the other hand, when the processing unit 104 determines that a fact 110 matches an existing fact object 118, the processing unit 104 may first evaluate whether the contents of the matched fact objects 118 already reflect all of the information associated with the fact 110. For example, the processing unit 104 may determine that an additional entity participated in a conversation associated with the fact object 118 based on the fact 110. In the example, the processing unit 104 may update an associated entities data field and a fact description data field to include a reference to the new entity. As another example, the processing unit 104 may update a snippets data field of the fact object 118 to include a snippet from the reference document 111 associated with the fact 110. If the processing unit 104 determines that the information from the fact 110 is already reflected in the corresponding data field of the matched fact object 118, the processing unit 104 may refrain from updating the representative data fields of the fact objects 118.

It should be appreciated that the processing unit 104 may perform the fact object update process in the non-destructive manner described above. For example, the processing unit 104 may be configured to refrain from updating the matched fact object 118 only in cases where there is an exact match between the contents of the fact 110 and the target data field of the matched fact object 118. In cases where there is a semantic match or no match at all between the contents of the fact 110 and the target data field of the matched fact object 118, the processing unit 104 may be configured to append the content of the fact 110 to the content already present in the data field or generate a new entry for the data field that combines the content of the fact 110 to the content already present in the data field. In some embodiments, generating the new entry for the data field may include averaging values together or inputting the content of the fact 110 to the content already present in the data field into the fact generating machine learning model 108 or another similar model to produce a combined summary. For example, in cases where a fact object 118 is updated to include content from different reference documents 111, the fact object 118 may include a reference to both of the different reference documents 111 in one of the data fields (see e.g., the document reference field 304 shown in FIG. 3).

In some embodiments, the processing unit 104 may be configured to merge multiple fact objects 118 together. The merge process may include the processing unit 104 determining a similarity score or ranking metric for the fact objects 118 as described above when identifying duplicate facts 110 and/or a matching fact object 118 for a fact 110. After determining that two fact objects 118 are sufficiently similar (e.g. based on a similarity score or ranking matric), the processing unit 104 may then merge the two fact objects 118. The merging of fact objects 118 may be done using the non-destructive process as described above. In particular, the processing unit 104 may merge two or more fact objects 118 by appending the material in from the same data fields of each of the one or more fact objects 118 and/or generating a new combined entry for the same data fields as described above. Furthermore, in some embodiments, some of the data fields in the one or more fact objects 118 may be may be generated by processing the merged contents of the data fields through the fact generating machine learning model 108 with a modified version of the fact extraction prompt 116 as described in more detail herein in connection with FIG. 3.

As illustrated, the processing unit 104 may be configured to generate one or more fact summaries 120 based on the fact objects 118. For example, a user of the workspace 102 may interact with a user interface to initiate the generation of the one or more fact summaries 120. Additionally, in some embodiments, the processing unit 104 may automatically generate the one or more fact summaries 120 in response to a trigger condition (e.g., a threshold number of reference documents 111 being processed by the fact generating machine learning model 108). The one or more fact summaries 120 include structured presentations of at least some of the one or more fact objects 118 according to contents of the data fields. The one or more fact summaries 120 may also be stored in the memory unit 106 or other data store of the workspace 102.

As shown in FIG. 1 the computing environment 100 may be communicably coupled to a client device 122 on which the one or more fact summaries 120 may be presented. The client device 122 may be any suitable user device (e.g., a personal computer, mobile phone, tablet, etc.). The client device 122 may be operatively coupled to the workspace 102 via wired or wireless means known in the art and may include a user interface. For example, the client device 122 may execute a dedicated application, web browser, etc. as known in the art configured to interface with the workspace 102. In response to user interactions with workspace 102, the processing unit 104 may provide the one or more fact objects 118, the one or more fact summaries 120, documents from the corpus of documents 103, and/or other data associated with the workspace 102 to the client device 122 for presentation thereat.

With reference now to FIG. 2, specific features of the fact extraction prompt 116 and one or more facts 110 will be discussed in more detail. As shown in FIG. 2, the fact extraction prompt 116 includes analysis instructions 200 and case context data 201. It should be appreciated that the fact extraction prompt 116 may include additional, fewer, or sets of instructions, which may be arranged in alternative sequences to that shown in FIG. 2.

In general, the case context data 201 includes background material on the matter that the fact generating machine learning model 108 is to utilize when analyzing content of the reference document 111. The analysis instructions 200 and the case context data 201 are combined with the reference document 111 and provided as an input to the fact generating machine learning model 108. The input into the fact generating machine learning model 108 may be a single set of inputs simultaneously input into the fact generating machine learning model 108 or a sequenced set of inputs sequentially input into the fact generating machine learning model 108. For example, the processing unit 104 may combine the reference document 111 with the fact extraction prompt 116 by appending the raw text of the reference document 111 together with the fact extraction prompt 116 or by appending a document reference marker to the fact extraction prompt 116 that the fact generating machine learning model 108 may use to recall the reference document 111 from a working memory or cache of the workspace 102.

The case context data 201 may be generated from manual user input via an application executing in workspace 102 and/or from automatic processing of background documents included in the corpus of documents 103. For example, in some embodiments, a case context machine learning model (not depicted) associated with the workspace 102 may generate at least some of the case context data 201. In these embodiments, the processing unit 104 may input the background documents and a case context prompt into the case context machine learning model to generate at least some of the case context data. The background documents may be selected from the corpus of documents 103 and may include specific document types that are regularly generated at the initial stage of a matter. For example, when the matter relates to a lawsuit, the background documents may include initial filing or prefiling materials (pre-suite demand letters, plaintiff complaint, defendant response, etc.). Additional details of this process are shown and described in the Application noted by attorney docket number 32646/70317P filed on ______, which is incorporated by reference herein in its entirety.

Turning to the example components of the case context data depicted in FIG. 2, the case context data 201 may include an analysis objective 202. In general, the analysis objective 202 may comprise an optional input that indicates one or more arguments related to the matter associated with the corpus of documents 103. These one or more arguments, when included, provide specific context the fact generating machine learning model 108 uses when generating or identifying components of the one or more facts 110 (see e.g., the assigned alignment indicator 228 and explanation 230 discussed below).

As shown in FIG. 2, the case context data 201 may also include an overview 203 of the matter, issues 204 present in the matter, people 206 relevant to the matter, relevant entities 208 related to the matter, and/or additional context data 210. The overview 203 may comprise a text summary detailing general features of the matter such as background on key entities and people, substantive allegations being made in relation to the matter, known relevant dates, etc.

The issues 204 may include a specific listing of different issue areas relevant to the matter. In some embodiments, each of the issues 204 may be expressly defined by user input to the workspace 102. In some embodiments, the issues 204 may describe component issues of the analysis objective 202 (e.g., each issue 204 may relate to different elements of the one or more arguments). In some embodiments, the issues 204 may include a list of issues identified directly by an opposing party in litigation or a list of issues identified from a document production or similar request from the opposing party. Furthermore, the issues 204 may include issues identified independent of opposing party requests such as issues identified from initial user review of the corpus of documents 103 and/or predictions of issues that may be identified from further manual or analysis of the corpus of documents 103. Including the different issues 204 enables the fact generating machine learning model 108 to assess relevance of a fact with respect to different elements.

Each of the issues 204 may include a title and corresponding text description that the fact generating machine learning model 108, as directed by the fact extraction prompt 116 references when analyzing the one or more reference documents 111 and identifying the one or more facts 110. For example, the issues 204 may include a list of issues names and accompanying definitions. The analysis instructions 200 may direct the fact generating machine learning model 108 to associate an issue name with an output fact 110 when the material extracted or identified from the reference document 111 for that output fact 110 sufficiently corresponds to the provided definition for the issue 204. The issues 204 may also include an issue section label 236 that the analysis instructions 200 utilizes to direct the fact generating machine learning model 108 thereto when generating portions of the one or more facts 110 (e.g., the fact issues 220 described below).

The people 206 and relevant entities 208 may be text data that identify particular persons or legal entities involved with the matter. The text data for the people 206 and the relevant entities 208 may be received as user input by the processing unit 104 and/or may be extracted from corresponding people and entity data objects of the workspace 102.

The analysis objective 202, the overview 203, the people 206, and relevant entities 208 may be compiled together and organized with a background section label 237 within the fact extraction prompt 116. However, it should be appreciated that in other versions of the fact extraction prompt 116 each of the analysis objective 202, overview 203, people 206, and relevant entities 208 may be combined in other configurations with accompanying labels similar to the issue section label 236 and background section label 237. For example each of the analysis objective 202, overview 203, people 206, and relevant entities 208 may be separately labeled sections of the fact extraction prompt 116. Whether compiled together or arranged in other possible configurations, the associated labels may provide a marker that the analysis instructions 200 utilize to direct the fact generating machine learning model 108 to the relevant material when generating the one or more facts 110.

In some embodiments, the case context data 201 may also include relevant document criteria. The relevant document criteria may provide instructions for how the fact generating machine learning model 108 identifies relevancy of the reference document 111 with respect to the issues 204 or other material in the case context data 201. Relevancy markers may be output by the fact generating machine learning model 108 as part of the document summary 234 discussed below.

The analysis instructions 200 define how the fact generating machine learning model 108 is to analyze the case context data 201. Even in embodiments where portions of the case context data 201 includes user generated data, the specific instructions included in the analysis instructions may not be user-modifiable. For example, the analysis instructions 200 may include an initial instructions and scope overview section 211 that orients the fact generating machine learning model 108 about the nature of the analysis and includes a location marker for where the one or more reference documents 111 is found in the input (e.g. where the reference document 111 is appended to the fact extraction prompt 116 or the memory location where the reference document 111 may be retrieved from). The analysis objective 202 may also define a structure and content of respective components of the one or more facts 110 output from the fact generating machine learning model 108 and the manner in which to analyze the case context data 201 when outputting the respective components of the one or more facts 110.

In some embodiments, the analysis instructions 200 include an output structure definition 212 that describes each component to be output by the fact generating machine learning model 108 and controls how the fact generating machine learning model 108 is to output those components as the one or more facts 110 (e.g., provide the output in a specific JSON, XML, etc. format). In other embodiments, the structure definition 212 may instruct the fact generating machine learning model to output the various components in an unstructured manner. Regardless, the components of the one or more facts 110 may include a fact name 213, a fact description 214, one or more snippets 216 extracted from the one or more reference documents 111, a supporting document indicator 217, a date 218 associated with the one or more facts, fact issues 220 to which the one or more facts 110 relate, matter related entities or people 222 with which the one or more facts 110 are associated, an assigned importance score 224 for the one or more facts 110, an explanation 226 for the importance score assignment, an assigned alignment indicator 228, an explanation 230 for the alignment indicator assignment, and/or additional comments 232 on or material from the one or more reference documents 111. It should be appreciated that these particular components of the one or more facts 110 is one example, and that in other embodiments, the one or more facts 110 may include additional, fewer, or different components.

As shown in FIG. 2, the analysis instructions 200 may include further instructions 238 that provide additional detailed directives with respect to the output structure definition 212 such as specific individual instructions for each section of the output structure definition 212 (e.g., specific detailed instructions for generating each of the fact name 213, fact description 214, one or more snippets 216, date 218, fact issues 220, people 222, assigned importance score 224, explanation 226, assigned alignment indicator 228, explanation 230, and/or additional comments 232 as described herein).

The fact name 213 may be a short text identifier or summary of the general features of a corresponding fact 110. To generate the text of the fact name 213, the analysis instruction 200 may instruct the fact generating machine learning model 108 to generate a title or one sentence summary that distinguishes the fact 110 from other facts. In some embodiments, the fact name may simply be a sequentially numbered fact identifier generated independent of the fact generating machine learning model 108.

The fact description 214 may be a longer multi-sentence or paragraph length text summarizing the general content of the corresponding fact 110. To generate the fact description 214, the analysis instructions 200 may include an explicit instruction to the fact generating machine learning model 108 to provide a useful summary of the content of the fact 110.

The one or more snippets 216 include one or more text passages extracted from the input reference document 111. In general, the one or more snippets 216 are configured to support the fact 110 such as supporting the text of the fact name 213, the fact description 214, and/or other components of the fact 110. To identify the one or more snippets 216, the analysis instructions 200 may include an explicit instruction for the fact generating machine learning model 108 to provide direct excerpts or snippets from the one or more reference documents 111 that supports the fact 110. The one or more snippets 216 may also include location indicators (e.g., formal citations, page numbers, line numbers, paragraph indicators etc.) describing where the one or more snippets 216 occur within the input reference document 111. In some embodiments, the one or more snippets 216 may be a required output of the fact generating machine learning model 108. In these embodiments, the analysis instructions 200 may direct the fact generating machine learning model 108 to generate a particular fact 110 from the input reference document 111 only in cases where the fact generating machine learning model 108 can identify at least one supporting snippet 216 to include in the particular fact 110.

The supporting document indicator 217 may include a text description of the reference document 111 such as a title or file name and/or a link to where the reference document 111 is stored in the data store 114. In some embodiments, the analysis instructions 200 may direct the fact generating machine learning model 108 to copy text or metadata of the reference document 111 as the supporting document indicator 217.

The date 218 may be a value directly extracted or interpolated from the reference document 111 by the fact generating machine learning model 108 as directed by the analysis instructions 200. For example, the fact generating machine learning model 108 may directly extract the date 218 from date formatted text or metadata values of the reference document 111. However, in other cases, the fact generating machine learning model 108 may generate the date 218 based on a combination of date formatted text or metadata values and other non-date formatted text of the reference document 111 (e.g., the date 218 may have a generated value of “February 2” where relevant text in the reference document 111 includes “two days before February 4”). The fact generating machine learning model 108 may also normalize the date 218 to a particular format (e.g., “dd/mm/yyyy,” “Month Day, year,” etc.) and/or time zone specified in the fact extraction prompt 116.

The fact issues 220 and matter related entities or people 222 may include text strings or other identifiers that indicate which of the issues 204, people 206, and relevant entities 208 from the case context data 201 to which the fact 110 relates. To identify the fact issues 220 and the related entities or people 222, the analysis instructions 200 may include explicit instructions directing the fact generating machine learning model 108 to select the fact issues 220 and the related entities or people 222 from the issues 204, the people 206, and the relevant entities 208 provided in the case context data 201. For example, the issues 220 and matter related entities or people 222 may indicate that the fact generating machine learning model 108 directly identified matching text corresponding to the issues 204, people 206, and relevant entities 208 from the case context data 201 in the reference document 111 in relation to a particular factual matter noted in the reference document 111. Furthermore, the issues 220 and matter related entities or people 222 may indicate that the fact generating machine learning model 108 identified text in the reference document 111 that is associated with the particular factual matter and has a high likelihood of being related to the issues 204, people 206, and relevant entities 208 from the case context data 201 (e.g., may be a semantic match rather than an exact text match or a description of known features of the issues 204, people 206, or relevant entities 208 without an exact text match to names).

The assigned importance score 224 for the one or more facts 110 may include a value or other indicator of how important the underlying fact is to the matter as a whole and or to the fact issues 220 associated with the fact 110. To generate the assigned importance score 224, the analysis instructions 200 may include explicit instructions for the fact generating machine learning model 108 to assign a score to the fact in a defined range (e.g., 0-5, 0-9, etc.) and a description of the characteristics of facts associated with one or more of the values within the defined range. For example, the analysis instructions 200 may include a scoring rubric 240 that the fact generating machine learning model 108 uses to assign the importance score 224 to the fact 110. In particular, the scoring rubric 240 may define a rating scale that the fact generating machine learning model 108 uses to generate the assigned importance score 224 of the one or more facts. The scoring rubric 240 may include a section label that the analysis instructions 200 utilizes to direct the fact generating machine learning model 108 thereto when the fact generating machine learning model 108 is following the portion of the analysis instructions 200 for generating the assigned importance score 224 (e.g., a portion of the further instructions 238).

In some embodiments, the assigned importance score 224 may be used to filter the one or more facts 110 that are output from the fact generating machine learning model 108. For example, the workspace 102 may filter facts 110 that do not satisfy at least a threshold level of importance. Alternatively, the analysis instructions 200 may direct the fact generating machine learning model 108 to only output one or more facts 110 that have an importance score 224 exceeding the threshold level of importance. In some embodiments, the threshold level of importance may be set or customized by user input before the corpus of documents 103 are fed into the fact generating machine learning model 108 as reference documents 111. This automatic filtering process may help to speed up the fact detection process, enabling faster processing the documents in the corpus of documents 103.

The explanation 226 for the importance score 224 may include text describing a justification for the assigned importance score 224. In some embodiments, the justification includes an analysis generated by the fact generating machine learning model 108 of the already generated importance score 224. In particular, the analysis instructions 200 may include explicit instruction text that directs the fact generating machine learning model 108 to (1) describe why the generated importance score 224 makes sense based on content of the reference document 111 and/or (2) provide additional context that supports the generated importance score 224.

The assigned alignment indicator 228 may include a value, number, text, or other indicator representing a helpful, harmful, or neutral alignment of the fact 110 with respect to the fact issues 220 associated with the fact 110 or with respect to the analysis objective 202. To generate the assigned alignment indicator 228, the analysis instructions 200 may include instructions that direct the fact generating machine learning model 108 to determine whether the fact material identified in the refence document 111 is helpful, harmful, or neutral relative to the text of the overview 203, the analysis objective 202, and/or the fact issues 220. The analysis instructions 200 may also dictate a particular value that the fact generating machine learning model 108 is to use to indicate helpful, harmful, or neutral (e.g., −1 for harmful, 0 for neutral, +1 for helpful, etc.). In some embodiments, the analysis instructions 200 may direct the fact generating machine learning model 108 do indicate additional degrees of helpfulness or harmfulness of the fact materials (e.g., very helpful, somewhat helpful, neutral, somewhat harmful, very harmful, etc.).

The explanation 230 for the alignment indicator 228 may include text describing a justification of the assigned alignment indicator 228. This justification may be similar to the justification for the assigned importance score 224 expect that it is directed at the assigned alignment indicator 228. In particular, the analysis instructions 200 may include instructions that direct the fact generating machine learning model 108 to (1) describe why the assigned alignment indicator 228 makes sense based on content of the reference document 111 and/or (2) provide additional context that supports the assigned alignment indicator 228.

The additional comments 232 may include further material from the referent document 111 that is relevant or noteworthy that does strictly align with other delineated components of the one or more facts 110. To identify or generate the additional comments 232, the analysis instructions 200 may include explicit instruction that direct the fact generating machine learning model 108 to identify any additionally relevant material from the reference document 111 that is not already noted in other portions of the fact 110.

The analysis instructions 200 may also include a document injection section 242 that labels the beginning of the reference document 111 within the input to the fact generating machine learning model 108. The document injection section 242 may also include the location marker for the reference document 111 that is provided in the initial instructions and scope overview section 211.

Furthermore, as shown in FIG. 2, the fact generating machine learning model 108 may additionally output a document summary 234 of the reference document 111 along with the one or more facts 110. The document summary 234 summarizes the content and nature of the reference document 111. This may include summarizing the facts 110 extracted from the reference document 111. The document summary 234 may be saved in the data store 114 as linked metadata for the reference document 111. In some embodiments, the analysis instructions 200 may direct the fact generating machine learning model 108 to generate a formalized summary with associations to matter knowledge and facts 110 that are extracted from the reference document 111 based on context provided in the fact extraction prompt 116. This context can include user input that directly influences the document summary 234. Generating both the document summary 234 and one or more facts 110 via the same prompt to the fact generating machine learning model 108 may save processing resources by extracting a complete set of relevant data from the reference document 111 with only a single call to the fact generating machine learning model 108.

With reference now to FIG. 3, mapping of the one or more facts 110 into the one or more fact objects 118 will be discussed in more detail. The processing unit 104 may map each of the components of the one or more facts 110 to corresponding data fields 300 of the one or more fact objects 118. As described herein, the analysis instruction 200 may define a structure for the components of the one or more facts 110 so as to enable the transfer of each component from the one or more facts 110 to the corresponding data fields 300. However, in some embodiments, the processing unit 104 may parse some or all of the one or more facts 110 to identify each component before mapping into the corresponding data field 300. Furthermore, when mapping the components of the one or more facts 110 into the corresponding data fields 300, the processing unit 104 may further process or transform the content of the one or more facts 110 based on a configured data type of the target field. In some embodiments, the processing unit 104 may reference a mapping template stored in the memory unit 106 or other data storage component of the workspace 102 when mapping the one or more facts 110 to corresponding data fields 300. The mapping template may instruct the processing unit 104 on how the content of the one or more facts 110 relate to the corresponding data fields 300 of the one or more fact objects 118.

In the illustrated example, the processing unit 104 maps the fact name 213 to a fact title field 301. The fact title field 301 may include a fixed length text/string field that directly accepts the fact name 213 without transformation by the processing unit 104.

In the illustrated example, the processing unit 104 maps the fact description 214 to a description field 302. The description field 302 may include a long text/string field that directly accepts the fact description 214 without transformation by the processing unit 104.

In the illustrated example, the processing unit 104 maps the supporting document indicator 217 to a document reference field 304. The document reference field 304 may be a multi-object field that stores one or more reference or links to the reference documents 111 from which the facts 110 associated with the fact object 118 were identified. In these embodiments, the processing unit 104 may be configured to transform the supporting document indicator 217 into a properly formatted link to the reference documents 111. However, in some embodiments, no transformation may be needed because the supporting document indicator 217 is already a properly formatted link or the document reference field 304 is instead configured as a text field to accept the text of the supporting document indicator 217.

In the illustrated example, the processing unit 104 maps the one or more snippets 216 to an excerpt field 306. The excerpt field 306 may include a long text string field that receives the one or more snippets 216 without transformation by the processing unit 104. However, in some embodiments, the excerpt field 306 may include an array of text fields so that in cases where the one or more snippets 216 include more than a single snippet, each of the one or more snippets 216 may be mapped by the processing unit 104 into a distinct element in the array.

In the illustrated example, the processing unit 104 maps the fact issues 220 to an issues field 308. The issues field 308 may include a multi-object field that stores links to issue objects of the workspace 102 that represent the issues 204. In these embodiments, the processing unit 104 may be configured to transform text of the fact issues 220 into a properly formatted link. Alternatively, the issues field 308 may include a short or long text field that directly accepts text data of the fact issues 220.

In the illustrated example, the processing unit 104 maps the matter related entities or people 222 to an entity/people field 310. The entity/people field 310 may include multi-object field that stores links to people or entity object of the workspace 102. In these embodiments, the processing unit 104 may transform text of the matter related entities or people 222 into properly formatted links. However, in other embodiments, the entity/people field 310 may include a short or long text field that directly accepts the text of the matter related entities or people 222.

In the illustrated example, the processing unit 104 maps the date 218 to a date field 312. The date field 312 may be a date format field. In these embodiments, the processing unit 104 may be configured to transform the data of the date 218 from a non-date format field into the date format of the date field 312 (e.g., converting a text string or numbers of the date 218 to the date format, transforming from a first date format to a second date format, etc.).

In the illustrated example, the processing unit 104 maps the assigned importance score 224 to a custom importance field 314. The custom importance field 314 may include a text/string field and/or a numerical data field that accepts the assigned importance score 224 directly from the fact 110. Furthermore, the data fields 300 may include an impact data field 316. The impact data field 316 may include an indication of a user selection or choice on the importance of the one or more fact objects 118 and may include a contextual relationship to the custom importance field 314.

In the illustrated example, the processing unit 104 maps the explanation 226 to a custom arguments field 317. The custom arguments field 317 may include a text/string field that accepts the explanation 226 directly from the fact 110.

In the illustrated example, the processing unit 104 maps the assigned alignment indicator 228 to an alignment field 318. The alignment field 318 may include a custom text or data field that directly stores the assigned alignment indicator 228 without transformation by the processing unit 104. In some embodiments, one portion of the alignment field 318 may store a value sign value (e.g., +, −, 0) that represents the helpful, harmful, or neutral alignment of the one or more facts 110 as described herein. However, in some embodiments the alignment field 318 may instead include text or another value that denotes further degrees of alignment. These further degrees of alignment may include very helpful, somewhat helpful, neutral, somewhat harmful, and very harmful. In other embodiments, the further degrees of alignment may include a numerical value representing how helpful or harmful the fact is on a defined scale (e.g., 0-10, 0-100, etc.).

In the illustrated example, the processing unit 104 maps the explanation 230 to a custom reasons for alignment field 319. The custom reasons for alignment field 319 may include a text/string field that accepts the explanation 230 directly from the fact 110.

In the illustrated example, the processing unit 104 maps the additional comments 232 to a comments field 320. The comments field 320 may be a long text/string type field that stores the additional comments 232 without transformation by the processing unit 104.

It should be appreciated that the particular corresponding data fields 300 of the one or more fact objects 118 shown in FIG. 3 is one example, and that in other embodiments, the one or more fact objects 118 may include additional, fewer, or different data fields 300.

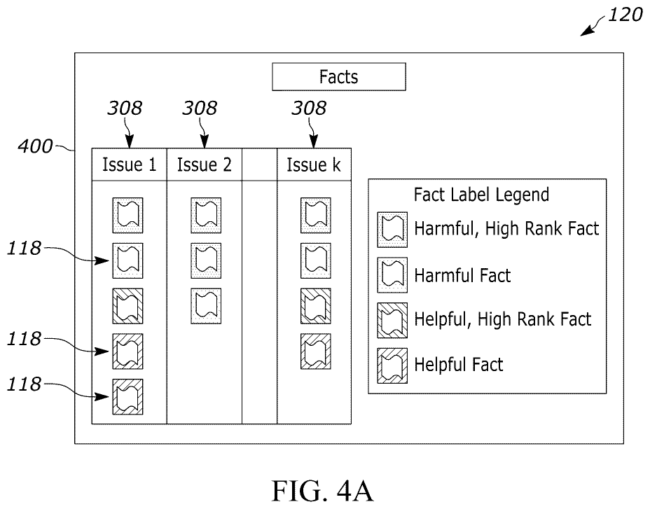

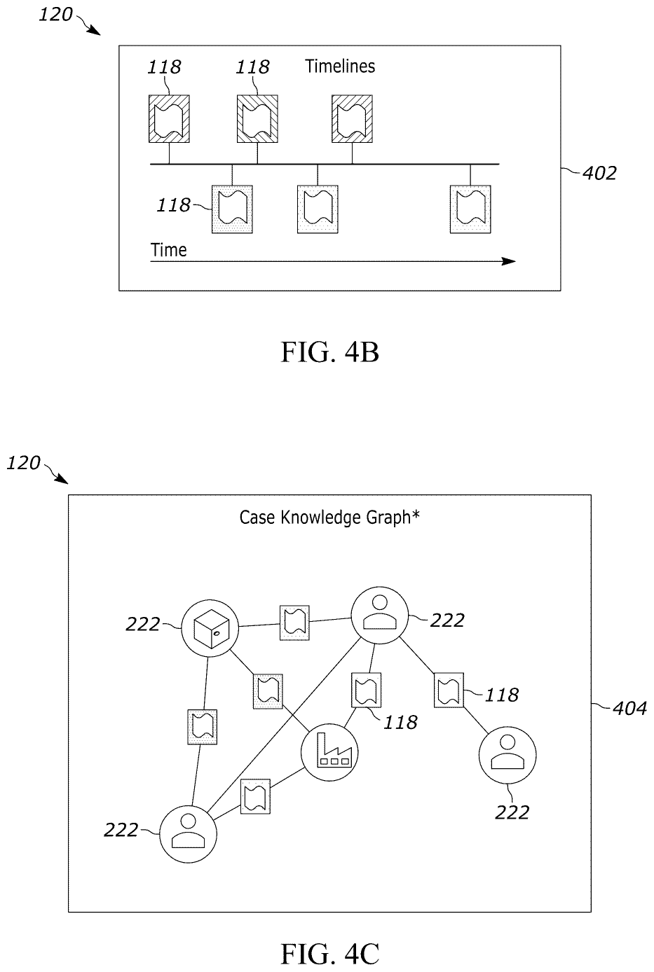

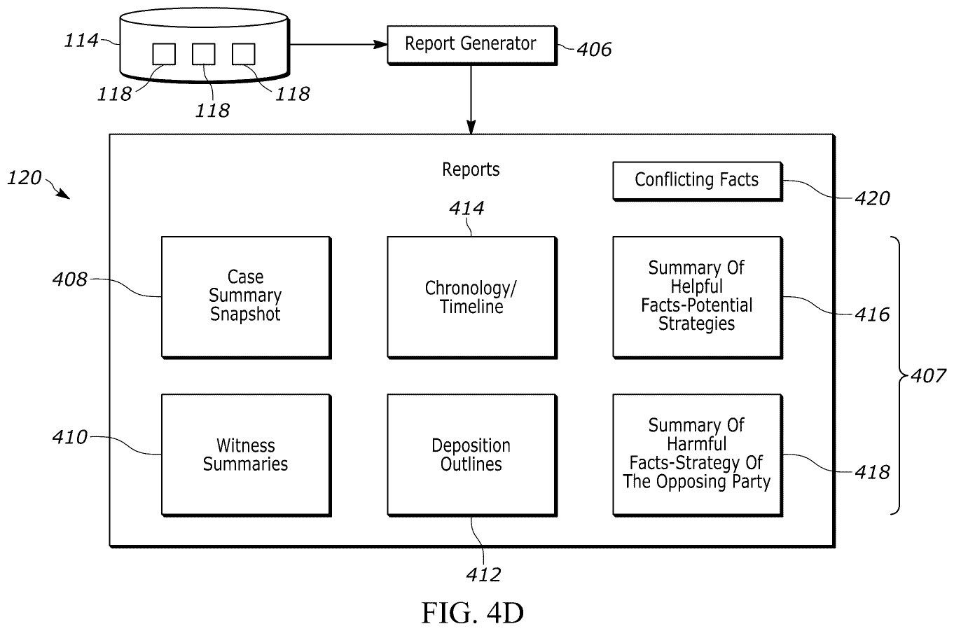

FIGS. 4A-4C show example organized displays 400, 402, 404, respectively, of examples of the one or more fact summaries 120. The organized displays 400, 402, 404 may represent a presentation of data included in the plurality of fact objects 118 that may be presented by the client device 122 when interacting with the workspace 102. In some embodiments, user interactions with one or more applications executing in the workspace 102 may trigger the generation of the displays 400, 402, 404.

Starting with FIG. 4A, depicted is a display 400 related to identifying the documents within the corpus of documents 103 with the strongest alignment (either helpful or harmful) with respect to the issues 204. Within the organized display 400 the structured presentations may include an ordered listing of the one or more fact objects 118 based on the alignment values in the alignment field 318 with respect to each issue 204. For example, the display 400 may show the most harmful fact objects with respect to an issue at the top of the display 400 followed by less harmful fact objects. Afterwards, the display 400 may show the most helpful fact objects followed by less helpful fact objects. Of course, this reflects one example organization of displaying harmful/helpful alignment and other displays may organize the fact objects in a different manner.

The organized display 400 may also include a visual indication of the alignment indicators 228 stored in the alignment field 318. For example, each of the one or more fact objects 118 may be colored, include a colored icon, or text value that indicates whether the one or more fact objects 118 was identified as helpful, harmful, neutral, etc. The coloring or other icon may also denote the further degrees of helpful, harmful, or neutral as described herein. For example, as shown in FIG. 4A high rank harmful facts may be colored differently from harmful facts, high rank helpful facts, and helpful facts.

Turning to FIG. 4B, the timeline display 402 may include a chronologically ordered display of the at least some of the one or more fact objects 118 according to the date fields 312. This chronological display may be organized along a horizontal timeline, but other alternative orders are possible (e.g., vertical).

Turning to FIG. 4C, a case knowledge graph 404 may include a display of icons or other representations of the contents of the entity/people fields 310 connected to mutually relevant fact objects 118 (or icons representative thereof) as indicated by the data fields 300. In some embodiments, such as embodiments where the entity/people fields 310 include the links to entity and people objects, an entity/people manager of the workspace 102 may be utilized by the processing unit 104 to assist in populating data represented by the case knowledge graph 404. To generate the case knowledge graph 404, the processing unit 104 may first identify a set of the one or more fact objects 118 that are associated with a set of matter related people or entities from the data fields 300 of the one or more fact objects 118. These sets may include all of the one or more fact objects 118 and the matter related entities or people 222 or a select subset thereof (e.g., user input received by the workspace 102 may limit the case knowledge graph 404 to display of only a subset of the matter related entities or people 222 specified by the user input). The processing unit 104 then generates the case knowledge graph 404 from the identified sets of the one or more fact objects 118 and the matter related entities or people 222.

In addition to the displays 400, 402, 404, as shown in FIG. 4D, the one or more fact summaries 120 may include one or more reports 407. The processing unit 104 may generate the reports 407 by processing the one or more fact objects 118 through a report generator 406. The reports 407 may include text displays on the client device 122 and/or digital text file outputs of the report generator 406 that are viewable within the workspace 102 or other computing environments. The reports 407 may include a case or matter summary snapshot report 408 that provides a summarized overview of all the one or more fact objects 118 for the matter. In some embodiments, the report generator 406 may algorithmically generate the case or matter summary snapshot report 408 by combining the contents in each fact title field 301 and/or the contents in each description field 302 into a single report. However, in other embodiments, the report generator 406 may comprise a machine learning model that processes the contents of the data fields 300 of the one or more fact objects 118 (or a subset of the data fields 300 such as the contents of the fact title fields 301 and description fields 302) according to instructions in a case summary prompt. In embodiments that utilize a machine learning model, the case summary prompt may direct the machine learning model to generate a summary of the one or more fact objects 118.

The reports 407 may also include witness summaries 410 that summarizes information about respective witness entities. For example, a witness summary 410 may summarize witness statements included in the corpus of documents, facts involving the witness, and/or other information associated with the witness.

In some embodiments, the report generator 406 may algorithmically generate the witness summaries 410 from the one or more fact objects 118 by identifying those of the one or more fact objects 118 related to the entity object associated with the witness. The report generator 406 may parse the fact title field 301, the description field 302, and/or the entity/people field 310 to identify those of the one or more fact objects 118 related to witnesses (e.g., the fact name 213content of the fact title field 301 or description field 302 mentions a witness generally or the entity/people field 310 relates the fact object 118 to a known witness in the matter). In these embodiments, the algorithmic report generator 406 may combine the contents in each fact title field 301 and/or the contents of each description field 302 of the identified one or more fact objects 118 into a single report.

Alternatively, in embodiments where the report generator 406 implements a machine learning model, the report generator 406 may generate the witness summaries 410 according to instructions in a witness summary prompt. In particular, the witness summary prompt may direct the report generator 406 to generate a summary of witness statements or testimony from the one or more fact objects 118 (e.g., from all of the one or more fact objects 118 or an identified subset that refence witnesses generally or known specific witnesses).

The reports 407 may also include deposition outlines 412. The report generator 406 may generate the deposition outlines 412 in an algorithmic matter and/or using a machine learning model. In embodiments where the report generator 406 utilizes a machine learning model, the report generator 406 may generate the deposition outlines 412 according to instructions in a deposition outline prompt. In particular, the deposition outline prompt may direct the machine learning model to generate an outline of questions to ask during a deposition based on the facts referenced in the one or more fact objects 118.

The reports 407 may also include a timeline report 414. The timeline report 414 may include a written report that textually describes the chronology depicted in the timeline display 402. In some embodiments, the report generator 406 may algorithmically generate the timeline report 414 by ordering the one or more fact objects 118 (or icons representative thereof) based on the values present in the date fields 312. In other embodiments, the report generator 406 may input a timeline prompt to a machine learning model to generate the timeline report 414 according to instructions in a timeline prompt. In particular, the timeline prompt may direct the machine learning model to generate a timeline graphic or report from the one or more fact objects 118.

The reports 407 may also include a first summary 416 of a first set of the one or more fact objects 118 for which the alignment field 318 indicates a helpful alignment and a second summary 418 of a second set of the one or more fact objects 118 for which the alignment field 318 indicates a harmful alignment. In some embodiments, the report generator 406 may algorithmically generate the first summary 416 and the second summary 418 by combining the contents of each fact title field 301 and/or the contents of each description field 302 for those of the one or more fact objects 118 having the helpful alignment and those having the harmful alignment respectively into a single report. In other embodiments, the report generator 406 may input an alignment summary prompt in a machine learning model to generate the first summary 416 and/or the second summary 418. In particular, the alignment summary prompt may direct the machine learning model to identify and summarize fact objects 118 that indicate a specified alignment (e.g., helpful, harmful neutral, etc.)

Additionally, the reports 407 may include a conflicting fact report 420. In the conflicting fact report 420 the structured presentations of the at least some of the one or more fact objects 118 may include a visual indication of sets of the one or more fact objects 118 which include conflicting content as identified between one or more of the data fields. The report generator 406 may input a conflict checking prompt in a machine learning model to generate the conflicting fact report 420. In particular, the conflict checking instructions may direct the machine learning model to identify sets of the one or more fact objects 118 that include conflicting content as identified between one or more of the data fields 300. The machine learning model may then provide the conflicting fact report 420 as an output.

In some embodiments, the reports 407 may be annotated to reference relevant ones of the one or more fact objects 118. In these embodiments, the prompt input by the report generator 406 to the machine learning model may direct the machine learning model to annotate the output report to include references to the one or more fact objects 118 that relate to content of the report. For example, the machine learning modal may annotate reports 407 to note fact objects 118 that support or contradict factual claims included in the reports 407.

In some embodiments, the machine learning models used by the report generator 406 as described herein may utilize the same trained parameter sets regardless of which of the reports 407 is being generated. Furthermore, these parameter sets may be the same as those of the fact generating machine learning model 108. In these embodiments, differences in the outputs of the models are dictated by differences between the fact extraction prompt 116, the case summary prompt, the witness summary prompt, the deposition outline prompt, the timeline prompt, the alignment summary prompt, etc.

In some embodiments, the processing unit 104 may check the accuracy of one or more facts 110 output from the fact generating machine learning model 108 to ensure that the contents in the one or more fact objects 118 reflect correct and true information gathered from the documents in the corpus of documents 103. The accuracy check may also be used to improve the quality of the one or more facts 110 generated by the fact generating machine learning model 108 over time.

To facilitate the accuracy check, the processing unit 104 receives feedback on accuracy of the one or more facts 110 and/or the one or more fact objects 118 and updates the fact extraction prompt 116 and/or one or more parameters of the fact generating machine learning model 108 based on the feedback. The feedback may be generated by manual user review, automatic review by the processing unit 104 or other computing system, and/or review by combinations thereof of the one or more facts 110 or the one or more fact objects 118. For example, the processing unit 104 may determine whether representations of the content of the reference document 111 included in the one or more facts 110 or the one or more fact objects 118 are commensurate with the content of the reference document 111. In some embodiments, the processing unit 104 may compare the contents of the reference document 111 to material in the one or more facts 110 or the one or more fact objects 118 that should include a verbatim extraction (e.g., the one or more snippets 216 or the contents of the excerpt fields 306). In these embodiments, the workspace 102 will check whether the full text content of the supposedly extracted material is actually present in the reference document 111. Similar verbatim matching may also check whether the matter related entities or people 222 included in the one or more facts 110 are actually present in the one or more reference documents 111. However, in some embodiments, the workspace 102 may alternatively determine whether representations of the content of the reference document 111 are included in the one or more facts 110 or the one or more fact objects 118 using a semantic or non-verbatim comparison. In these embodiments, the processing unit 104 may assess how similar the text of the reference document 111 is to the contents of one or more facts 110 or the one or more fact objects 118 and deem the material of the reference document 111 to be included where there is sufficient similarity (e.g., a similarity score or other metric meets a threshold value).

Then, the processing unit 104 may generate, based on the determined presence of the extractions, people, or entities within the one or more facts 110 or the one or more fact objects 118, an accuracy score for the one or more facts 110 or the one or more fact objects 118 as the feedback and update the fact extraction prompt or one or more parameters of the fact generating machine learning model 108 so that future accuracy scores will be improved.

In some cases, the improvement to the fact extraction prompt 116 and or parameters of the fact generating machine learning model 108 may be done iteratively in pre-deployment training stage. The fact extraction prompt may also include a description of one or more matter issues that the fact generating machine learning model references when analyzing the one or more reference documents and identifying the one or more facts and data and instructions for assigning an alignment indicator to the one or more facts. The alignment indicator indicates a helpful, harmful, or neutral alignment of the one or more facts with respect to at least one of the one or more matter issues.

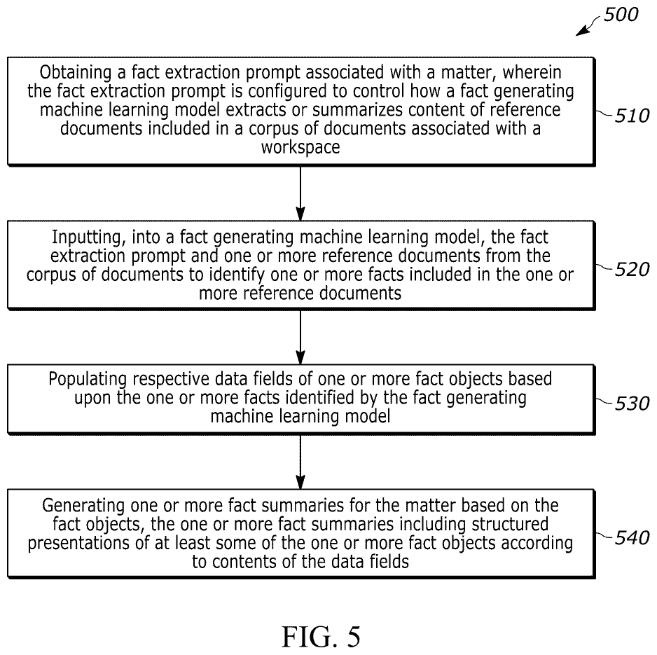

FIG. 5 shows a computer-implemented method 500 for using the fact generating machine learning model 108 to generate the one or more facts 110 and the one or more fact objects 118. The method 500 may be executed by the workspace 102 via execution by the processing unit 104 of instructions stored on the memory unit 106.

At block 510, the computer-implemented method 500 includes obtaining a fact extraction prompt (e.g., the fact extraction prompt 116) associated with a matter, wherein the fact extraction prompt is configured to control how a fact generating machine learning model (e.g., fact generating machine learning model 108) extracts or summarizes content of reference documents (e.g., the reference document 111) included in a corpus of documents (e.g., the corpus of documents 103) associated with a workspace (e.g., the workspace 102).

At block 520, the computer-implemented method 500 includes inputting, into a fact generating machine learning model, the fact extraction prompt and one or more reference documents from the corpus of documents to identify one or more facts (e.g., one or more facts 110) included in the one or more reference documents. The fact extraction prompt comprises case context data and analysis instructions. The case context data includes background material on the matter that the fact generating machine learning model is to reference when analyzing content of the one or more reference documents. The case context data may also include an analysis objective associated with the corpus of documents. The extracting and summarization of the content of the one or more reference documents relates to the analysis objective may relate to the analysis objective. The case context data may also include one or more of an overview of the matter, issues present in the matter, people relevant to the matter, and relevant entities related to the matter. The method 500 may also include inputting background documents for the matter into a case context machine learning model to generate at least some of the case context data as an output of the case context machine learning model. The analysis instructions define a structure and content of respective components of the one or more facts output from the fact generating machine learning model and a manner in which to reference the case context data when extracting or summarizing the content of the one or more reference documents. The fact extraction prompt also includes a description of one or more matter issues that the fact generating machine learning model references when analyzing the one or more reference documents and identifying the one or more facts, and data and instructions for assigning an alignment indicator to the one or more facts, the alignment indicator indicating a helpful, harmful, or neutral alignment of the one or more facts with respect to at least one of the one or more matter issues. The fact extraction prompt may also include a scoring rubric that defines a rating scale that the fact generating machine learning model uses to generate an importance score of the one or more facts, and wherein the structured presentations of the at least some of the one or more fact objects include an ordered listing based on the importance scores. The analysis instructions in the fact extraction prompt may direct the fact generating machine learning model to output one or more of a fact name, a fact description, snippets extracted from the one or more reference documents, a date associated with the one or more facts, matter issues to which the one or more facts relates, matter related entities or people with which the one or more facts is associated, an assigned importance score for the one or more facts, an explanation for the importance score assignment, an assigned alignment indicator, or an explanation for the alignment indicator assignment. The analysis instructions in the fact extraction prompt may direct the fact generating machine learning model to not output facts with importance levels below a threshold.

At block 530, the method includes populating respective data fields (e.g., corresponding data fields 300) of one or more fact objects (e.g., one or more fact objects 118) based upon the one or more facts identified by the fact generating machine learning model.

At block 540, the method includes generating one or more fact summaries (e.g., one or more fact summaries 120) for the matter based on the one or more fact objects. The one or more fact summaries include structured presentations of at least some of the one or more fact objects according to contents of the data fields. The structured presentations of the at least some of the one or more fact objects include a visual indication of the alignment indicator. The method 500 may include generating the one or more summaries by inputting a first set of the one or more fact objects for which an alignment indicator field of the data fields includes the helpful alignment into a report generator to generate a first summary of the first set of the one or more fact objects and inputting a second set of the one or more fact objects for which the alignment indicator field of the data fields includes the harmful alignment into the report generator to generate a second summary of the second set of the one or more fact objects. The method 500 may also include generating the one or more summaries by identifying a set of the one or more fact objects that are associated with a set of matter related people or entities and generating a case knowledge graph in which the structured presentations of the at least some of the one or more fact objects include a display of connected icons relating to the matter related people and entities the set of the one or more fact objects. The method 500 may also include generating the one or more summaries by generating a timeline display in which the structured presentations of the at least some of the one or more fact objects includes a chronologically ordered display of the at least some of the one or more fact objects according to date values within the data fields. The method 500 may also include generating the one or more summaries by inputting at least some of the one or more fact objects into a report generator machine learning model with conflict checking instructions, the conflict checking instructions directing the report generator machine learning model to identify sets of the one or more fact objects that include conflicting content as identified between one or more of the data fields and receiving a conflicting fact report as an output of the report generator machine learning model, wherein the structured presentations of the at least some of the one or more fact objects in the conflicting fact report include a visual indication of the sets of the one or more fact objects which includes the conflicting content.

The method 500 may also include receiving feedback on accuracy of the one or more facts and updating the fact extraction prompt or one or more parameters of the fact generating machine learning model based on the feedback. The method 500 may also include determining whether (i) representations of the content of the one or more reference documents from which the one or more facts were extracted are commensurate with the content of the one or more reference documents, or (ii) that people or entities included in the one or more facts are associated with the one or more reference documents, generating, based on the determination, an accuracy score for the one or more facts as the feedback, and updating the fact extraction prompt or one or more parameters of the fact generating machine learning model to improve the accuracy score. To determine that people or entities included in the one or more facts are associated with the one or more reference documents the method 500 may include searching text of the one or more reference documents for the people or entities included in the one or more facts and determining that the people or entities included in the one or more facts are associated with the one or more reference document when the searching finds a match in the text of the one or more reference documents

It is understood that the blocks of the method 500 need not occur strictly in the order shown.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computer system comprising:
one or more processors; and
one or more non-transitory, computer-readable media storing instructions that, when executed by the one or more processors, cause the computer system to:
obtain a fact extraction prompt associated with a matter, wherein the fact extraction prompt is configured to control how a fact generating machine learning model extracts or summarizes content of reference documents included in a corpus of documents associated with a workspace;
input, into a fact generating machine learning model, the fact extraction prompt and one or more reference documents from the corpus of documents to identify one or more facts included in the one or more reference documents;
populate respective data fields of one or more fact objects based upon the one or more facts identified by the fact generating machine learning model; and
generate one or more fact summaries for the matter based on the one or more fact objects, the one or more fact summaries including structured presentations of at least some of the one or more fact objects according to contents of the data fields.

2. The computer system of claim 1 wherein:
the fact extraction prompt comprises case context data and analysis instructions,
the case context data includes background material on the matter that the fact generating machine learning model is to reference when analyzing content of the one or more reference documents, and
the analysis instructions define a structure and content of respective components of the one or more facts identified by the fact generating machine learning model and a manner in which to reference the case context data when extracting or summarizing the content of the one or more reference documents.

3. The computer system of claim 2, wherein the case context data comprises:
an analysis objective for an inquiry associated with the corpus of documents,
wherein the extracting or summarizing of the content of the one or more reference documents relates to the analysis objective.

4. The computer system of claim 2, wherein the case context data includes one or more of an overview of the matter, issues present in the matter, people relevant to the matter, and relevant entities related to the matter.

5. The computer system of claim 2, wherein the instructions, when executed by the one or more processors, cause the computer system to:
input background documents for the matter into a case context machine learning model to generate at least some of the case context data as an output of the case context machine learning model.

6. The computer system of claim 1, wherein the fact extraction prompt comprises:
a scoring rubric that defines a rating scale that the fact generating machine learning model uses to generate an importance score of the one or more facts,
wherein the structured presentations of the at least some of the one or more fact objects include an ordered listing based on the importance scores.

7. The computer system of claim 1, wherein the fact extraction prompt comprises:
a description of one or more matter issues that the fact generating machine learning model references when analyzing the one or more reference documents and identifying the one or more facts, and
instructions for assigning an alignment indicator to the one or more facts, the alignment indicator indicating a helpful, harmful, or neutral alignment of the one or more facts with respect to at least one of the one or more matter issues.

8. The computer system of claim 7, wherein the structured presentations of the at least some of the one or more fact objects include a visual indication of the alignment indicator.

9. The computer system of claim 7, wherein to generate the one or more fact summaries, the instructions, when executed by the one or more processors, cause the computer system to:
input a first set of the one or more fact objects for which an alignment indicator field of the data fields includes the helpful alignment into a report generator to generate a first summary of the first set of the one or more fact objects; and
input a second set of the one or more fact objects for which the alignment indicator field of the data fields includes the harmful alignment into the report generator to generate a second summary of the second set of the one or more fact objects.

10. The computer system of claim 1, wherein to generate the one or more fact summaries, the instructions, when executed by the one or more processors, cause the computer system to:
identify a set of the one or more fact objects that are associated with a set of matter related people or entities; and
generate a case knowledge graph in which the structured presentations of the at least some of the one or more fact objects include a display of connected icons relating to the matter related people and entities the set of the one or more fact objects.

11. The computer system of claim 1, wherein to generate the one or more fact summaries, the instructions, when executed by the one or more processors, cause the computer system to:
generate a timeline display in which the structured presentations of the at least some of the one or more fact objects includes a chronologically ordered display of the at least some of the one or more fact objects according to date values within the data fields.

12. The computer system of claim 1, wherein to generate the one or more fact summaries, the instructions, when executed by the one or more processors, cause the computer system to:
input at least some of the one or more fact objects into a report generator machine learning model with conflict checking instructions, the conflict checking instructions directing the report generator machine learning model to identify sets of the one or more fact objects that include conflicting content as identified between one or more of the data fields; and
receive a conflicting fact report as an output of the report generator machine learning model, wherein the structured presentations of the at least some of the one or more fact objects in the conflicting fact report include a visual indication of the sets of the one or more fact objects which includes the conflicting content.

13. The computer system of claim 1, wherein analysis instructions in the fact extraction prompt direct the fact generating machine learning model to output one or more of a fact name, a fact description, snippets extracted from the one or more reference documents, a date associated with the one or more facts, matter issues to which the one or more facts relates, matter related entities or people with which the one or more facts is associated, an assigned importance score for the one or more facts, an explanation for the importance score assignment, an assigned alignment indicator, or an explanation for the alignment indicator assignment.

14. The computer system of claim 1, wherein analysis instructions in the fact extraction prompt direct the fact generating machine learning model to not output facts with importance levels below a threshold.

15. The computer system of claim 1 wherein the instructions, when executed by the one or more processors, cause the computer system to:
receive feedback on accuracy of the one or more facts; and
update the fact extraction prompt or one or more parameters of the fact generating machine learning model based on the feedback.

16. The computer system of claim 15, wherein the instructions, when executed by the one or more processors, cause the computer system to:
determine whether (i) representations of the content of the one or more reference documents from which the one or more facts were extracted are commensurate with the content of the one or more reference documents, or (ii) that people or entities included in the one or more facts are associated with the one or more reference documents;
generate, based on the determination, an accuracy score for the one or more facts as the feedback; and
update the fact extraction prompt or one or more parameters of the fact generating machine learning model to improve the accuracy score.

17. The computer system of claim 16, wherein to determine that people or entities included in the one or more facts are associated with the one or more reference documents, the instructions, when executed by the one or more processors, cause the computer system to:
search text of the one or more reference documents for the people or entities included in the one or more facts; and
determine that the people or entities included in the one or more facts are associated with the one or more reference documents when the search finds a match in the text of the one or more reference documents.

18. A computer-implemented method for generating one or more fact objects for one or more reference documents for a matter, the method comprising:
obtaining a fact extraction prompt associated with a matter, wherein the fact extraction prompt is configured to control how a fact generating machine learning model extracts or summarizes content of reference documents included in a corpus of documents associated with a workspace;
inputting, into the fact generating machine learning model, the fact extraction prompt and the one or more reference documents from the corpus of documents to identify one or more facts included in the one or more reference documents;
populating respective data fields of the one or more fact objects based upon the one or more facts identified by the fact generating machine learning model; and
generating one or more fact summaries for the matter based on the one or more fact objects, the one or more fact summaries including structured presentations of at least some of the one or more fact objects according to contents of the data fields.

19. The computer-implemented method of claim 18 wherein:
the fact extraction prompt comprises case context data and analysis instructions,
the case context data includes background material on the matter that the fact generating machine learning model is to reference when analyzing content of the one or more reference documents, and
the analysis instructions define a structure and content of respective components of the one or more facts identified by the fact generating machine learning model and a manner in which to reference the case context data when extracting or summarizing the content of the one or more reference documents.

20. The computer-implemented method of claim 18 wherein the fact extraction prompt comprises:
a description of one or more matter issues that the fact generating machine learning model references when analyzing the one or more reference documents and identifying the one or more facts, and
data and instructions for assigning an alignment indicator to the one or more facts, the alignment indicator indicating a helpful, harmful, or neutral alignment of the one or more facts with respect to at least one of the one or more matter issues.
